(19) United States
(12) Patent Application Publication
(10) Pub. No.: US 2026/0219677 A1
(43) Pub. Date: Jul. 30, 2026

(54) METHOD FOR DETERMINING A TRAVEL ENVELOPE ALONG A PLANNED TRAVEL TRAJECTORY, CONTROL DEVICE, VEHICLE, AND COMPUTER PROGRAM

(71) Applicant: Continental Autonomous Mobility Germany GmbH, Ingolstadt (DE)

(72) Inventors: Yong-Ho Yoo, Kelkheim (DE); Nicolas Stein, Bad Nauheim (DE); Hendrik Deusch, Wiesbaden-Bierstadt (DE); Matthias Ehricke, Frankfurt am Main (DE)

(73) Assignee: Continental Autonomous Mobility Germany GmbH, Ingolstadt (DE)

(21) Appl. No.: 19/139,710

(22) PCT Filed: Nov. 24, 2023
(86) PCT No.: PCT/DE2023/200234

§ 371 Date: Jun. 16, 2025

(30) Foreign Application Priority Data
Dec. 14, 2022 (DE) 10 2022 213 587.3

(51) Int. Cl. G05D 1/622; G05D 101/20

(52) U.S. Cl. CPC G05D 1/637; G05D 2101/20

(57) ABSTRACT

The invention relates to a method for determining a travel envelope along a planned travel trajectory (5), comprising the steps of:
providing the travel trajectory (5), wherein the travel trajectory (5) comprises at least one curved trajectory segment (6, 7), wherein a curvature of the travel trajectory (5) has a constant sign,
determining at least a first polygon (8), the circumference of which describes a vehicle contour (10) at a first vehicle position (11) on the trajectory segment (6, 7), and a second polygon (9), the circumference of which describes the vehicle contour (10) at a second vehicle position (12),
establishing a pivot point (13) of the vehicle contour (10), which has the greatest distance from the curved line (14) during a movement of the vehicle (1) from the first vehicle position (11) to the second vehicle position (12), and approximating the curved line (14) by at least two legs (16, 17) of at least one triangle (18) which encloses the curved line (14),
forming two convex polygons (22, 23, 27, 28) from the first polygon (8), the second polygon (9) as well as the at least two legs (16, 17) of the triangle (18) as a travel envelope segment (24, 26) of the curved trajectory segment (6, 7),
determining the travel envelope from the at least one travel envelope segment (24, 26).

### TECHNICAL FIELD

A method for determining a travel envelope along a planned travel trajectory is disclosed. Furthermore, the embodiments relate to a control device, a vehicle and a computer program.

### BACKGROUND

Various geometric descriptions can be used for travel trajectories of a vehicle, which describe a vehicle movement between two points. A travel trajectory can, by way of example, be composed of arc-shaped segments having a constant radius and/or of straight segments without a curvature. In order to attain traveling comfort, travel trajectories which comprise segments having a continually changing curvature can also be used.

The determination of a travel trajectory from clothoids is described, by way of example, in the printed document DE 10 2019 204 651 A1. The clothoids each have a continuous curvature. In order to avoid an analytical determination of the clothoids, these are established by means of a geometric approximation method.

However, the consequence of using travel trajectories having a changing curvature can be that the computational effort mounts for functions which are based on the course of the travel trajectory. This is, for example, the case during the determination of a travel envelope which is used for collision detection. To this end, the travel envelope, which approximates the area swept over by a vehicle during a movement along the travel trajectory, can be compared with the position of objects in the environment of the travel trajectory so that a collision with an object in the surroundings can already be detected before the start of a vehicle movement and can be anticipated, by way of example, by a modified course of the travel trajectory. Since the travel envelope extends along the travel trajectory, the computational effort for determining the travel envelope mounts, as a general rule, for geometrically more complex travel trajectories.

In the case of partially automated or fully automated parking maneuvers, computer-based trajectory planning often has to dynamically perform collision detection, that is to say compare a travel envelope determined as a function of a currently provided and/or currently driven travel trajectory with an environmental model. The environmental model can also be continually updated so that changes to the travel trajectory or to a further course of the travel trajectory, starting from the current travel position, can also be required during a parking maneuver. Such changes require a new collision check and, consequently, also the redetermination of a travel envelope adapted to the changed trajectory.

For example, in the case of travel trajectories having a non-constant curvature, travel envelopes can also be produced along the travel trajectory, which likewise have regions having a changing curvature at least in sections. However, the determination of such travel envelopes and also the collision determination based on such travel envelopes also require a comparatively large amount of computing power and, correspondingly, the utilization of powerful computing devices.

### SUMMARY

An object is therefore to indicate a method for determining a travel envelope along a planned travel trajectory, which reduces the computational effort during the determination of the travel envelope and/or during collision determination using the travel envelope.

To achieve this object, in the case of a method of the type mentioned at the outset comprises the following steps of:
providing the travel trajectory of the vehicle, wherein the travel trajectory comprises at least one curved trajectory segment, wherein a curvature of the travel trajectory has a constant sign in the curved trajectory segment,
determining at least a first polygon, the circumference of which describes a vehicle contour at a first vehicle position on the trajectory segment, and a second polygon, the circumference of which describes the vehicle contour at a second vehicle position on the trajectory segment,
establishing a pivot point of the vehicle contour, which has the greatest distance from the curved line during a movement of the vehicle from the first vehicle position to the second vehicle position, and approximating the curved line by at least two legs of at least one triangle which encloses the curved line,
forming two convex polygons from the first polygon, the second polygon as well as the at least two legs of the triangle as a travel envelope segment of the curved trajectory segment,
determining the travel envelope from the at least one travel envelope segment.

The travel trajectory of the vehicle is first provided, which describes, by way of example, a parking process such as pulling into or out of a parking space, or another driving maneuver. The travel trajectory comprises at least one curved trajectory segment, within which the travel trajectory has a curvature having a constant sign, i.e., the travel trajectory is consistently curved either to the left or to the right at least within the trajectory segment in the direction of travel of the vehicle. The method can be used in the case of trajectories which have at least one trajectory segment in which the curvature for example changes continuously or in which the curvature is not constant. The curvature can change, by way of example, linearly or non-linearly.

The travel trajectory can be composed of multiple trajectory segments which comprise different curvatures or different curvature directions. It is also possible that the travel trajectory comprises straight trajectory segments, via which two curved trajectory segments are connected, for example. The curvature of the curved trajectory can for example be such that a continuous course of the curvature is produced along the trajectory.

At least a first polygon and a second polygon are first established to determine the travel envelope for the at least one curved trajectory segment. The circumference of the first polygon describes the vehicle contour of the vehicle at a first vehicle position on the trajectory segment. Correspondingly, the circumference of the second polygon describes the vehicle contour at a second vehicle position on the trajectory segment. The second vehicle position on the trajectory segment is different from the first vehicle position, i.e., the first vehicle position and the second vehicle position are arranged offset along the travel trajectory or the trajectory segment. The first vehicle position can for example be located in front of the second vehicle position in the direction of travel of the vehicle along the travel trajectory. In this case, the first and the second vehicle position represent planned vehicle positions which the vehicle would take up during a movement along the travel trajectory and can consequently be different from an actual vehicle position in which the vehicle is situated.

For example, the first polygon can describe the vehicle contour as a function of the orientation of the vehicle at the first vehicle position and the second polygon can correspondingly describe the vehicle contour as a function of the orientation of the vehicle at the second vehicle position. The vehicle contour described in each case by the first polygon or the second polygon can consequently reflect the exact orientation of the vehicle when driving the travel trajectory at the first vehicle position or the second vehicle position so that a precise determination of the travel envelope is made possible.

A pivot point of the vehicle contour, that is to say a point on the circumference of the first polygon or of the second polygon, is subsequently established, which pivot point has the greatest distance from the curved line during a movement of the vehicle from the first vehicle position to the second vehicle position. The curvature of the curve along which the pivot point moves is established on the basis of the course of the curved trajectory segment. Based on a radius of curvature of the trajectory segment, the pivot point is constantly located on the radially outer edge or on the convexly curved side of the travel trajectory or of the trajectory segment. During the movement of the vehicle from the first position into the second position, the pivot point carries out the greatest pivot or the greatest pivoting movement, so that all other points of the vehicle contour are located on the same side as the pivot point between the pivot point and the trajectory segment. The pivot point can, by way of example, be a corner of the vehicle contour.

The curved line along which the pivot point moves is subsequently approximated by two legs of a triangle which encloses the curved line. In particular, the triangle is placed around the curved line such that the two legs are located on the radially outer side or on the convexly curved side of the curved line. In this way, it can be achieved that the legs of the triangle completely enclose the area actually swept over by the vehicle. The approximation of the curved line by the triangle consequently represents an upper estimate, which includes a certain safety margin.

Two convex polygons are subsequently formed as a travel envelope segment, wherein the convex polygons are formed as a function of the first polygon, the second polygon as well as the at least two legs of the triangle. In this context, a convex polygon may be understood to be a polygonal chain which only has outwardly facing corners. For such convex polygons, an overlap with a further polygon, by which, for example, an object located in the environment of the travel trajectory is described, can be simply checked. For example, the convex polygons can, in each case, be different from the first polygon and the second polygon.

Use of two convex polygons to describe the travel envelope segment provides that a collision check can be effected, for example, a check as to whether an object described by a polygon at least partially overlaps with a convex polygon, can be performed with comparatively low computing power. Therefore, the method is suitable for utilization in computing devices having a comparatively low computing power.

The travel envelope segment of the curved trajectory segment determined in this way is subsequently enlisted to determine the travel envelope. The travel envelope can be formed from multiple travel envelope segments, for example if the travel trajectory has multiple curved trajectory segments. Furthermore, it is possible that the travel envelope has additional travel envelope segments which are located along straight trajectory segments. In order to achieve the collision check, the travel envelope can for example be determined as a sequence of adjacent, convex polygons so that a collision check only has to be performed for a plurality of convex polygons.

The travel envelope determined in this way can subsequently be used for collision determination. For example, a check for the presence of collisions during a vehicle movement along the travel trajectory can be performed by comparing the travel envelope with the positions and/or extents of one or more objects in map information which describes the location of the objects relative to the travel trajectory.

In the event that a collision is determined, the travel trajectory can be replanned, or at least part of the travel trajectory can be replanned, by way of example, whereupon a collision check can be performed again.

In the event that no collision is ascertained for the travel trajectory, the vehicle can be moved, for example, partially autonomously or completely autonomously along the travel trajectory, or at least along a section of the travel trajectory. To this end, it can be provided that at least one actuator of the vehicle, for example a longitudinal guidance actuator and/or a lateral guidance actuator, is/are controlled as a function of a travel trajectory determined to be collision-free. Additionally or alternatively, a display device of the vehicle can also be controlled as a function of the determined travel envelope.

The method can in principle be utilized in the case of different geometries of travel trajectories. A simple mathematical description of the associated travel envelope segment or of the entire travel envelope comprising the travel envelope segment is produced even for more complex geometries of the travel trajectories, for example for trajectories with at least one segment having a non-constant curvature.

By determining the travel envelope segment assigned to the curved trajectory segment as two convex polygons, the computational effort for a collision check can be advantageously reduced, since the travel envelope segment no longer has any curved edges in this way. The curved edges which occur during the conventional formation of a travel envelope segment, which are created by the movement of the pivot point, may be approximated by the two legs of the triangle during the determination of the travel envelope segment according to the invention, so that the complete travel envelope segment can be described as two adjacent, convex polygons.

Correspondingly, the entire determined travel envelope can for example have travel envelope segments formed from two convex polygons for all of the curved trajectory segments of the travel trajectory. Corresponding travel envelope segments which are located along straight trajectory segments can also be described as convex polygons, e.g., as rectangles.

In a configuration, it can be provided that a travel trajectory is used, the curvature of which changes continuously at least in sections, and/or that a clothoid curve or a polynomial is used as a travel trajectory. The determination of the travel envelope according to the method is suitable for travel trajectories which have a continuous or constant change in curvature at least in sections. Consequently, a collision determination can also be effected for travel trajectories with a high level of traveling comfort.

Furthermore, the use of travel trajectories having a non-constant curvature at least in sections or a continuously changing curvature at least in sections makes it possible to take the actual tire position of the vehicle into account during the planning of the travel trajectory or the replanning of individual sections of the travel trajectory, so that pleasant and jerk-free control behavior or steering behavior of the vehicle is also produced, which cannot be achieved with a travel trajectory based purely on straight sections as well as sections having a constant curvature.

Accordingly, it can be provided that the vehicle contour described by the first polygon and the second polygon corresponds to the actual contour of the vehicle increased by a safety margin. The vehicle contour described in each case by the first polygon and the second polygon can consequently be an increased vehicle contour compared to the actual vehicle contour in order to provide a safety margin. In this way, the determined travel envelope represents an upward estimate of the area swept over by the vehicle, so that any inaccuracies can be taken into account or compensated for during the establishment of the vehicle position and/or the location of objects in the environment of the vehicle.

Accordingly, the at least one triangle can be formed by at least two tangents on the curved line as well as a straight line connecting the contact points of the tangents on the curved line. Each of the tangents forms a leg of the triangle, which extends from the respective contact point of the tangent up to the intersection point of the tangents. The third leg of the triangle is correspondingly formed by the straight line which connects the two contact points of the tangents on the curved line.

To determine the tangents, a further polygon can, for example, be established at a further vehicle position which is incrementally displaced along the travel trajectory from the first or second vehicle position, which further polygon describes the contour of the vehicle and consequently also describes the location of the pivot point. In the case of a smallest possible incremental distance between the further vehicle position and the first vehicle position or the second vehicle position, an approximation to the desired tangent is consequently produced by a straight line which runs through the respective pivot points. The incremental distance can be, by way of example, 1% of the length of the curved segment. However, depending on the desired accuracy of the tangent approximation, another, relative or absolute, incremental distance can also be chosen.

In a configuration, it can be provided that the first vehicle position is located at a starting point of the trajectory segment and the second vehicle position is located at an end point of the trajectory segment or that the first vehicle position and/or the second vehicle position is/are located between a starting point and an end point of the trajectory segment.

The distance between the first vehicle position and the second vehicle position along the travel trajectory can be established as a function of a height limit value which describes a maximum permissible height for the at least one triangle. The smaller the height limit value chosen is, the more vehicle positions located on the trajectory segment are required in order to approximate the curved lines with triangles while maintaining the height limit value. Furthermore, more vehicle positions located on the trajectory segment or more triangles are needed for trajectory segments having a large curvature in the case of the same height limit value than in the case of trajectory segments having a smaller curvature.

It can be provided that the two convex polygons are formed such that, together, they completely comprise at least the first polygon, the second polygon and the area comprised by the at least one triangle. Additionally, the convex polygons can also cover a further region which, by way of example, is opposite the at least one triangle and corresponds to the region swept over by the vehicle on the radially inner or concave side of the trajectory segment. Depending on the location of the first and the second vehicle position, the two convex polygons can also comprise further regions or areas.

Accordingly, it can be provided that a collision check is performed as a function of the determined travel envelope and an item of map information which describes at least one object in the environment of the travel trajectory.

The object positions and/or the geometric extents of the objects can be compared with the determined travel envelope which describes the area swept over by the vehicle during movement along the travel trajectory. If the travel envelope overlaps with an object described in the map information, a colliding object can thus be assumed.

An item of object information can subsequently be formed from the objects of the map information, wherein the object information contains the object or those objects from the map information which collide with the vehicle or a part of the vehicle during a movement along the travel trajectory or with which the vehicle collides during said movement.

If a collision with an object is determined during the collision check, a route along the travel trajectory which is to be driven by the vehicle without collision can subsequently be determined. The determination of the route to be driven without collision can comprise one or more of the following steps of:
providing the object information,
determining the position and arrangement of multiple items of contour information, which each describe the contour of the vehicle or a part of the vehicle, for various positions of the vehicle or the part of the vehicle along the travel trajectory,
determining contour information which collides with the object and collision-free contour information which is located closer to a starting point of the travel trajectory,
dividing the area between the collision-free contour information and the colliding contour information into multiple cells which are each assigned to a contour section of the contour information,
determining a cell overlapping with the object and a collision-free portion of the movement of the contour section assigned to the overlapping cell in the overlapping cell,
establishing a collision position on the travel trajectory as a function of the collision-free portion, and
determining a collision-free movement of the vehicle along the travel trajectory as a function of the collision position.

The determination of the route to be driven without collision can be performed for the entire travel trajectory or for the at least one trajectory segment for which the travel envelope was determined.

Accordingly, the object information can be determined from map information which describes one or more objects in the environment of the travel trajectory and a travel envelope, wherein the travel envelope at least approximately describes the area swept over by the vehicle when driving the travel trajectory.

The object positions and/or the geometric extents of the objects can be compared with the travel envelope or with the area swept over by the vehicle during movement along the travel trajectory. If the travel envelope overlaps with an object described in the map information, it can thus be assumed that it is a colliding object. The object information can subsequently be formed from the objects in the map information, wherein the object information contains those objects from the map information which collide with the vehicle during a movement along the travel trajectory or with which the vehicle collides during said movement. In addition to using a travel envelope to determine the colliding objects, other methods are also possible for ascertaining a possible collision between the object and the vehicle during a movement along the travel trajectory.

In order to be able to ascertain how far the vehicle can move along the travel trajectory until a collision of the vehicle or a part of the vehicle collides with a colliding object, the position and arrangement of multiple items of contour information, which each describe the contour of the vehicle or a part of the vehicle, are established for various positions of the vehicle along the travel trajectory. The positions for which an item of contour information is established in each case can be determined, by way of example, on the basis of specified absolute distance intervals along the travel trajectory and/or on the basis of specified relative distances based on the total length of the travel trajectory.

The contour information can reflect the actual vehicle geometry or a simplified form and/or a form only approximated to the actual form of the vehicle contour. Further, the contour information can be slightly increased compared to the actual vehicle contour in order to implement an additional safety margin.

In the case of the vehicle part, the contour information can also describe the actual geometry of the vehicle part or a simplified geometry. Accordingly, the vehicle part can be a movable vehicle part relative to a body of the vehicle, for example a wheel of the vehicle. A rectangle, by way of example, can be used as contour information for the wheel. In addition to a wheel, the collision of further vehicle parts, e.g., of movable structures such as crane booms, bucket arms, etc., can also be taken into account by means of the method.

An item of contour information which collides with the object is subsequently determined from the plurality of contour information. The contour information which collides with the object can be determined, for example, on the basis of an overlap of the vehicle contour described by the contour information with the object contour when the vehicle contour as well as the object contour are illustrated in a common map, or when comparing the mathematical descriptions of the vehicle contour or the contour information and the object contour based on a common coordinate system.

Furthermore, a further item of contour information is determined which does not collide with the object and which is located closer to a starting point of the travel trajectory. The position along the travel trajectory, which is assigned to the further contour information, corresponds for example to a position which the vehicle can approach from the starting point of the travel trajectory without a collision with the object occurring.

The area between the collision-free contour information and the colliding contour information is subsequently divided into multiple cells which are each assigned to a contour section or an edge of the contour information. That is to say that the cells each describe the area which extends between the contour section in the position of the vehicle assigned to the collision-free contour information and the position of the vehicle assigned to the colliding contour information. The form of the cells can depend on the geometry of the vehicle contour described by the contour information, for example on the form of the contour section. For example, the contour sections can each be a straight or a curved edge of the vehicle contour described by the contour information.

In a next step, a cell overlapping with the object as well as the collision-free portion of the movement of the contour section of the vehicle assigned to the overlapping cell in the overlapping cell are determined. The cell overlapping with the object can be determined, for example, on the basis of a geometric overlap of a description of the cell with an object description, based on a common coordinate system. The collision-free portion of the movement of the contour section refers, for example, to the ratio of the partial route between the contour section in the collision-free contour information and the contour section in the colliding contour information, on which there is no collision of the vehicle with the object or no overlap of the contour section with the object information, to the partial route on which the contour section rests on the object and/or overlaps with the object or intersects said object.

The collision-free portion is subsequently enlisted to determine a collision position on the travel trajectory. In other words, the collision-free portion represents a measure of the collision-free portion of a movement of the vehicle from the position of the vehicle assigned to the collision-free contour information to the position of the vehicle assigned to the colliding contour information, which can be transferred to the travel trajectory, for example.

The collision-free movement of the vehicle along the travel trajectory can subsequently be determined on the basis of the collision position. As a function of the determined collision-free movement, at least one actuator of the vehicle, for example a lateral guidance actuator and/or a longitudinal guidance actuator, can subsequently be controlled. In this way, the vehicle can be operated, by way of example, in partially automated or completely automated vehicle operation, for example in a partially automated or completely automated parking maneuver.

Additionally or alternatively to the control of the at least one actuator, a display device of the vehicle can also be controlled as a function of the determined, collision-free movement, wherein the display device represents the collision-free movement and/or an item of information derived from the collision-free movement for a user of the vehicle.

The method can for example be performed by a control device or a computing device. The control device can for example be a control device of the vehicle. The use of a control device external to the vehicle is also conceivable, wherein the external control device is communicatively connected to the vehicle for transmitting data.

The required computational effort for determining the route to be driven without collision can be reduced by taking into account the collision-free contour information and the colliding contour information as well as by determining the collision-free portion of the movement assigned to a contour section of the vehicle contour described by the contour information. The determination of the route to be driven without collision on the travel trajectory can for example be divided into multiple sub-steps, which are geometrically easy to describe and which can each be calculated with little effort, for travel trajectories having a comparatively complex mathematical description. Consequently, the required computational effort is reduced in the case of a computing device set up to carry out the method, so that the method can be carried out on computing devices having a comparatively low overall computing power.

The determining a route along the travel trajectory which can be driven without collisions, for example in the case of a travel trajectory which is assigned to a parking maneuver, such as a process of pulling into or out of a parking space, is that the vehicle operation of the vehicle along the travel trajectory is simplified. Depending on the determined collision position or the route which is to be driven without collisions until the collision position is reached, the maneuvering of the vehicle is made considerably easier, since, starting from the already determined travel trajectory, it is only necessary to replan the travel trajectory or a section of the travel trajectory, at least from the collision position.

A determined travel trajectory in which a collision with an object occurs can be used at least in accordance with the possible collision-free movement, which makes it possible to perform a necessary replanning of the travel trajectory at least from the collision position during the vehicle movement on the route to be driven without collision. This can help to ensure that a partially automated or completely automated driving maneuver performed as a function of the travel trajectory can be performed more quickly.

Accordingly, it can be provided that in the case of multiple items of contour information colliding with an object, that contour information which collides with the object closest to a starting point of the travel trajectory is determined as the colliding contour information. The closest object can for example be the closest object based on a direction of movement of the vehicle along the travel trajectory, i.e., the object which the vehicle approaches first during the movement along the travel trajectory or with which it would collide first.

In a configuration, it can be provided that a polygon, for example a convex polygon, is used as contour information and/or that an edge of the contour information is used as the contour section. When the contour information is described in each case as a polygon, for example as a convex polygon, the result is that it is easy to calculate the collision or the overlap of the contour information with a colliding object described in the object information. It is possible that a first polygon or a second polygon, which were established to determine the travel envelope, is used in each case as one or more items of contour information.

Accordingly, in the case of multiple objects overlapping with a cell, at least one further item of contour information can be determined, wherein the at least one further item of contour information is located at a position on the travel trajectory between the original positions. In other words, in the case that one of the cells between the collision-free contour information in the colliding information overlaps with two or more objects, a smaller distance can be chosen between the positions of the vehicle at each of which an item of contour information is established. That is to say that a further item of contour information is determined which is located at a further position on the travel trajectory between the positions of the vehicle assigned to the colliding contour information and the collision-free contour information. This represents a refinement of the spatial resolution, which can also be repeated until, for example, the cell only overlaps with a single object. In this way, it can be achieved that the collision-free movement of the vehicle along the travel trajectory is established until the collision with the first colliding object based on the travel trajectory.

In a configuration, it can be provided that the collision-free movement is determined up to an end point which is a safety margin away from the collision position. During the determination of the collision-free movement, taking the safety margin into account can prevent a collision with the object from occurring during an actual vehicle movement due to inaccuracies in establishing the vehicle's position and/or due to inaccuracies in the description of the object in the object information.

It is provided for a control device that it is set up to perform the method.

It is provided for a vehicle that it comprises a control device to perform the method.

The vehicle can be a motor vehicle, by way of example a passenger car, a truck or a commercial vehicle. Further, the vehicle can also be a movable robot, for example one which can move freely in space, a movable platform or similar.

A computer program comprises commands which prompt a control device to carry out a method.

All of the advantages and configurations described above in relation to the method also apply correspondingly to the control device, the vehicle as well as the computer program, and vice versa in each case.

### BRIEF DESCRIPTION OF THE DRAWING

Further advantages and details of the invention are set out by the drawings described below. These are schematic representations, wherein:

FIG. 1 shows an exemplary embodiment of a vehicle,

FIG. 2 shows a first example of a travel trajectory comprising two trajectory segments in order to explain an exemplary embodiment of a method,

FIG. 3 shows a diagram in which the curvature of the travel trajectory is plotted along its length in order to explain the exemplary embodiment of a method,

FIG. 4 shows a first example of a vehicle movement along a trajectory segment of the travel trajectory in order to explain the exemplary embodiment of a method,

FIG. 5 shows the area swept over by the vehicle during the vehicle movement according to the first example in order to explain the exemplary embodiment of a method,

FIG. 6 shows the approximation of the curved line by a triangle according to the exemplary embodiment of a method,

FIG. 7 shows the travel envelope segment determined by the exemplary embodiment of the method, which is assigned to the trajectory segment driven according to the first example,

FIG. 8 shows a second example of a travel trajectory comprising two trajectory segments in order to explain an exemplary embodiment of a method,

FIG. 9 shows the travel envelope segment determined by the exemplary embodiment of the method, which is assigned to the trajectory segment driven according to the second example,

FIG. 10 shows a block diagram of the exemplary embodiment of the method,

FIG. 11 shows a block diagram of a further exemplary embodiment of the method

FIG. 12 shows a representation of an item of contour information colliding with an object and of a collision-free item of contour information in order to explain the exemplary embodiment of the method, and

FIG. 13 shows a representation of the determination of a collision-free portion of the movement of a contour section in an assigned cell in order to explain the exemplary embodiment of the method.

### DETAILED DESCRIPTION

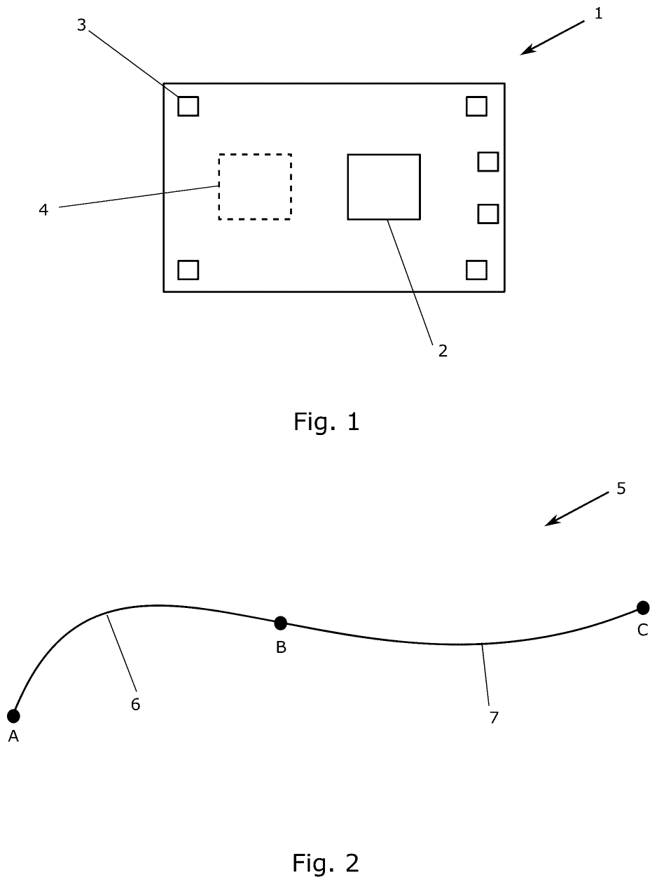

An exemplary embodiment of a vehicle 1 is depicted in FIG. 1. The vehicle 1 comprises a control device 2, a plurality of environmental sensors 3 as well as at least one actuator 4. The environmental sensors 3 can each be embodied, by way of example, as an ultrasonic sensor, as a camera, as a radar, as a lidar or similar. The at least one actuator 4 can be a longitudinal guidance actuator or a transverse guidance actuator of the vehicle 1. The environmental sensors 3 and the at least one actuator 4 are communicatively connected to the control device 2, wherein the corresponding connections are not depicted for reasons of clarity.

The control device 2 is set up to perform a method for determining a travel envelope along a planned travel trajectory 5. Such a travel trajectory 5 is depicted as an example in FIG. 2. The travel trajectory 5 comprises two curved trajectory segments 6, 7, wherein the first curved trajectory segment 6 extends between the points A and B and the second curved trajectory segment 7 extends between the points B and C.

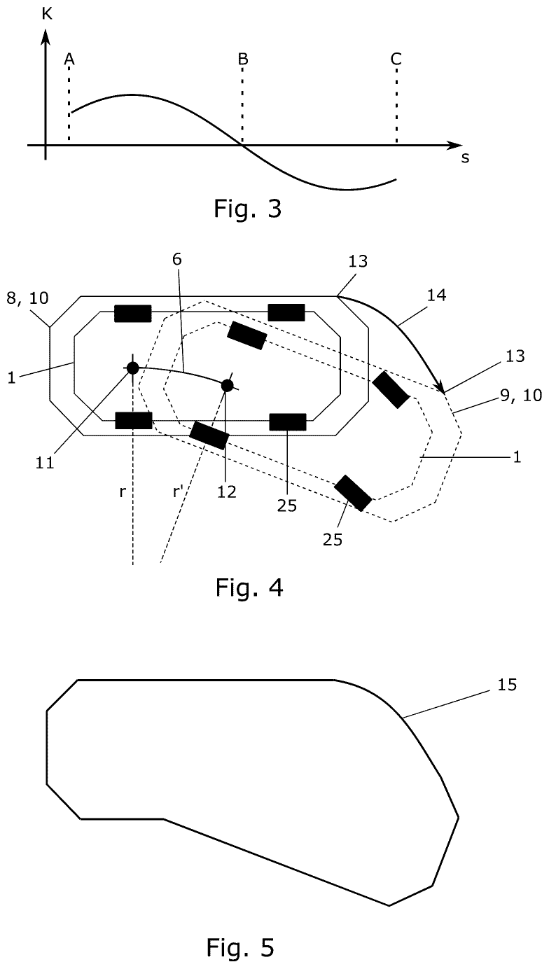

The curvature K of the travel trajectory 5 over the length s of the trajectory 5 is depicted in FIG. 3. The trajectory segments 6, 7 each have a curvature having a constant sign or a curvature in only one direction. The first trajectory segment 6 is curved to the right in the case of an exemplary direction of travel of the vehicle from A to point C, whereas the second trajectory segment 7 is curved to the left. A travel trajectory 5, the curvature of which changes continuously at least in sections and/or is a clothoid curve or a polynomial, is preferably used for the method for determining the travel envelope.

The travel envelope determined by the control device 2 approximates the area swept over by the vehicle 1 during a movement along the travel trajectory 5 and can be enlisted, by way of example, to determine a collision between the vehicle 1 and an object situated in the surroundings of the travel trajectory 5. The method for determining the travel envelope begins with the step of providing the travel trajectory 5 of the vehicle 1.

As depicted in FIG. 4, at least a first polygon 8 and a second polygon 9 (depicted here in dashed lines) are subsequently determined for the movement of the vehicle 1 along the first curved trajectory segment 6. The circumference of the first polygon 8 and the circumference of the second polygon 9 each describe a vehicle contour 10, wherein the first polygon 8 indicates the vehicle contour 10 at a first vehicle position 11 on the travel trajectory 5 and the second polygon 9 indicates the vehicle contour 10 correspondingly at a second vehicle position 12 on the travel trajectory 5.

The first vehicle position 11 can, by way of example, be located at a starting point of the trajectory segment 6, that is to say, for example, at point A, and the second vehicle position 12 can be located at an end point of the trajectory segment 6, that is to say, for example, at point B. Alternatively, it is possible that the first vehicle position 10 and/or the second vehicle position 11 are located between a starting point and an end point of the trajectory segment 6, for example, depending on the required accuracy of the desired travel envelope determination.

The associated radii of curvature r, r′ are in each case depicted schematically for the first vehicle position 11 and for the second vehicle position 12. The radii of curvature r, r′ can for example be different, or the trajectory segment 6 can have a curvature K which for example changes continuously with a constant sign.

The vehicle contour 10 described in each case by the polygons 8, 9 can be chosen to be slightly larger than the actual contour of the vehicle 1 for safety reasons. That is to say that the vehicle contour described by the first polygon 8 and the second polygon 9 can for example correspond to the actual contour of the vehicle 1 increased by a safety margin. Further, the vehicle contour 10 can be described by the polygons 8, 9 in a simplified geometric form in order to achieve the simplest possible mathematical description of the polygons 8, 9.

Thereafter, a pivot point 13 of the vehicle contour 10 is established, which has the greatest distance from the curved line 14 during the movement of the vehicle 1 from the first vehicle position 11 to the second vehicle position 12. The pivot point 13 can for example be a corner of the vehicle contour 10 or a corner of the polygons 8, 9 which is radially external based on the radii of curvature r, r′. In other words, the pivot point 13 is located on the convexly curved side of the trajectory segment 6. The location of the pivot point 13 based on the vehicle contour 10 can depend both on the direction of movement of the vehicle 1, the curvature of the respective trajectory segment 6 as well as the position of steerable wheels 25 of the vehicle 1 during the vehicle movement along the trajectory segment 6.

The area 15 swept over by the vehicle 1 during the movement from the first vehicle position 10 into the second vehicle position 11 is depicted in FIG. 5. The area 15 comprises the area of the first polygon 8, the area of the second polygon 9 as well as the area located between the polygons 8, 9 and the curved line 14. The area 15 depicted in FIG. 5 has the difficulty, for example for use in a travel envelope for collision detection, that it needs a comparatively complex mathematical description, for example in order to describe the section of the circumference of the area 15 that harks back to the curved line 14.

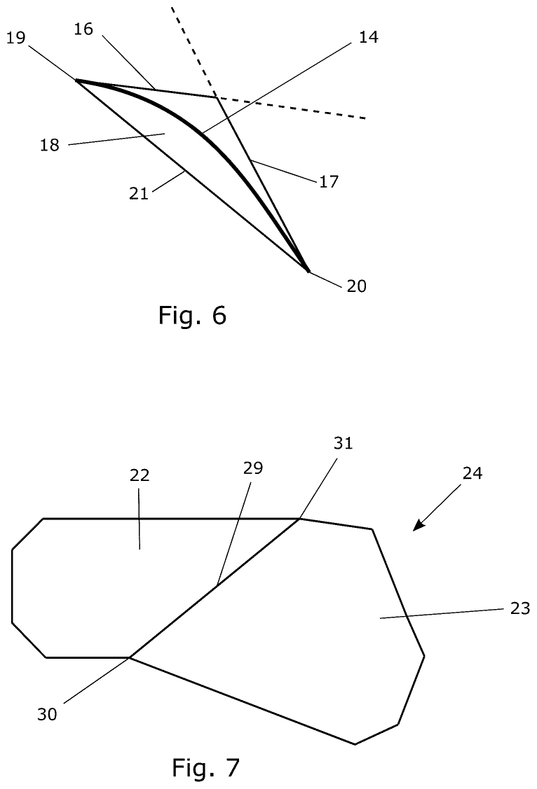

As depicted in FIG. 6, in the exemplary embodiment for determining the travel envelope, the curved line 14 is approximated by at least two legs 16, 17 of at least one triangle 18 which encloses the curved line 14 in order to make possible a simple mathematical description of the area swept over by the vehicle 1 during the movement from the first vehicle position 10 into the second vehicle position 11 as a travel envelope segment of the travel envelope.

The triangle 18 is formed by two tangents on the curved line 14 as well as by a straight line 21 connecting the contact points 19, 20 of the tangents on the curved line 14, wherein the tangents each represent one of the legs 16, 17 of the triangle. The contact points 19, 20 correspond to the pivot point 13 of the vehicle contour in the first vehicle position 11 or the second vehicle position 12. The curved line 14 is approximated by the legs 16, 17 of the triangle 18 based on the area swept over by the vehicle 1, so that the area actually swept over by the vehicle 1 is continuously enclosed by the subsequently determined travel envelope segment.

The tangents corresponding to the legs 16, 17 can be approximated in each case by a straight line which runs through the respective pivot points 13 when the vehicle 1 is arranged at two vehicle positions incrementally displaced along the travel trajectory 5 or the trajectory segment 6. To that end, the pivot point 13 at the first vehicle position 10 as well as at a further vehicle position which is incrementally displaced in the direction of travel of the vehicle 1 along the trajectory segment relative to the vehicle position 10 can be used for the determination of the tangent corresponding to the leg 16. For example, a hundredth of the length of the trajectory segment 6 can be used as the increment. Correspondingly, the tangent corresponding to the leg 17 can run through the pivot point 13 in the second vehicle position 11 as well as through the pivot point 13 at a further vehicle position displaced incrementally counter to the direction of travel along the trajectory segment 6. In this way, an easy determination of the legs 16, 17 on the basis of 2 points each is made possible.

In order to make it possible for the curved line 14 to be approximated as accurately as possible by the triangle 18, it can be provided that the distance between the first vehicle position 11 and the second vehicle position 12 along the travel trajectory 5 or the trajectory segment 6 is established as a function of a height limit value which describes a maximum permissible height for the at least one triangle 18. Depending on the height limit value for the at least one triangle 18, the curved line 14 can be approximated by multiple adjacent triangles 18. The smaller the height limit value, the more triangles 18 can be required for the approximation of the curved line 14. The more triangles 18 are used to approximate the curved line 14, the more accurately the course of the curved line 14 is approximated by the two legs which are utilized in each case per triangle 18. If no height limit value is used or a height limit value of infinity is assumed, each curved line 14 can be approximated by a single triangle 18. The height limit value utilized represents a measure of the additional safety margin during the approximation of the curved line 14.

As depicted in FIG. 7, two convex polygons 22, 23 are formed from the first polygon 8, the second polygon 9 as well as the two legs 16, 17 of the triangle 18 as the travel envelope segment 24 of the curved trajectory segment 6. The two convex polygons 22, 23 are formed such that they completely comprise at least the first polygon 8, the second polygon 9 as well as the area comprised by the at least one triangle 18. The entire area comprised by the first polygon 8, the second polygon 9 and by the at least one triangle 18 can be divided independently of the geometry of the first polygon 8, the second polygon 9 as well as the triangles 18, so that the two convex polygons 22, 23 are formed overall. For example, it is possible that the convex polygons are formed such that one of the convex polygons comprises the areas of all of the triangles. This can reduce the computational effort during a subsequent collision check since, by way of example, if the second vehicle position 12 changes, only the second convex polygon 23 has to be subsequently checked again in terms of a collision. For the example depicted in FIG. 7, the dividing line 29 between the two convex polygons runs through a point 30 which is located on the rear axle of the vehicle when it is arranged at a position on the trajectory segment centrally between the first vehicle position 11 and the second vehicle position 12. The further point 31 through which the dividing line 29 runs is chosen so that the triangle 18 is completely part of the second convex polygon 23.

Depending on the location of the first vehicle position and the second vehicle position 12 or depending on the location of the first polygon 8 and the second polygon 9, at least 1 of the convex polygons can also comprise an area which is located on the side of the travel trajectory 5 opposite the at least one triangle 18 and corresponds to the region swept over by the vehicle 1 during its movement.

The entire travel envelope for the travel trajectory 5 can be formed from multiple travel envelope segments 24. These can be determined for each curved trajectory segment of the travel trajectory 5 in a similar way to the first curved trajectory segment 6. If the curvature of the travel trajectory 5 changes sign, the travel trajectory 5 can be divided into two trajectory segments 6 which adjoin one another at the point corresponding to the zero point of the curvature, wherein a travel envelope segment is determined for each of the trajectory segments thus created. In the event that the travel trajectory 5 comprises straight, further trajectory segments, a rectangular travel envelope segment can be determined for each of these, for example, and can be enlisted to form the entire travel envelope.

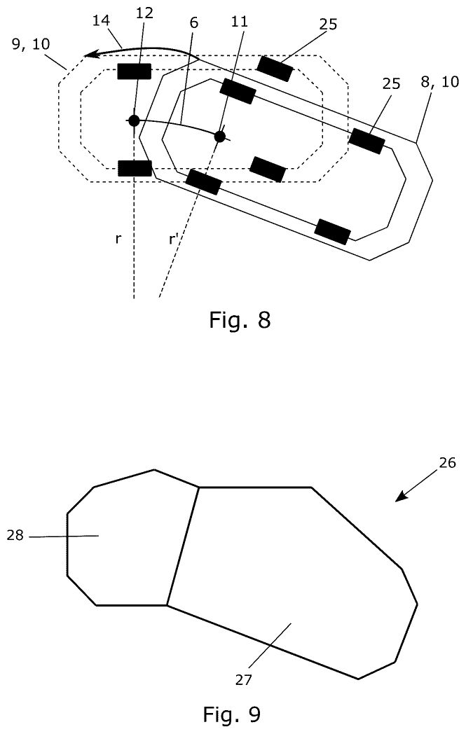

A second example of a vehicle movement is depicted in FIG. 8. For the sake of simplicity, the trajectory segment 6 described above is also enlisted for this exemplary embodiment. In this case, in contrast to the first example of the vehicle movement, the vehicle 1 moves backwards, wherein the first vehicle position 11 corresponds, for example, to point B and the second vehicle position 12 corresponds to point A on the trajectory segment 6.

Furthermore, in addition to a reverse direction of movement, the position of the steerable tires 25 of the vehicle 1 is different so that, compared to the first exemplary embodiment, a different area swept over by the vehicle 1 during the movement along the trajectory segment 6 is produced.

During this vehicle movement, the pivot point 13 of the vehicle contour 10 is located at a rear, radially external corner of the vehicle contour 10 based on the curvature of the trajectory segment 6. Here as well, the pivot point 13 moves along a curved line 14 which, as described above, is approximated by 2 legs 16, 17 of the triangle 18 for the formation of the travel envelope segment 26 assigned to the trajectory segment for this vehicle movement.

The travel envelope segment 26 for the trajectory segment 6 corresponding to the second vehicle movement is depicted in FIG. 9. The travel envelope segment 26 is formed again by 2 convex polygons 27, 28. These are formed, similarly to the previous description in relation to the first example of the vehicle movement, from the first polygon 8 at the first vehicle position 11, the second polygon 9 at the second vehicle position 12 as well as the at least one triangle 18 which is produced from the approximation of the curved line 14. Due to the different position of the steerable wheels 25 of the vehicle 1 during the second vehicle movement, the travel envelope segment 26 has a different geometry compared to the travel envelope segment 24 of the first vehicle movement.

The determination of the travel envelope segments 24, 26 can, as has been previously represented, be accomplished for a first vehicle position 11 and a second vehicle position 12 which correspond to the starting point or the end point of the respective trajectory segment. Alternatively, a travel envelope segment can also be determined for other vehicle positions 11, 12 or for multiple pairs of vehicle positions 11, 12 along the respective trajectory segment. The distance of the respective vehicle position 11, 12 or further used vehicle positions along the travel trajectory 5 or the trajectory segment under consideration can be specified as a portion of the length of the respective trajectory segment, as a fixed length and/or as a function of further boundary conditions. As a boundary condition, it can be required, for example, that the first and second vehicle positions 11, 12 used for the determination of a travel envelope segment are each chosen such that the first polygon 8 and the second polygon 9 at least partially overlap. First or alternatively, further types of boundary conditions can also be used.

The travel envelope formed from the at least one travel envelope segment 5 and 20, 26 can subsequently be compared for collision determination. To this end, the overlap between the travel envelope or its travel envelope segments, for example of the convex polygons forming the travel envelope segments, and objects in the environment of the travel trajectory 5 can be examined, for example. Objects in the environment of the vehicle can be both non-moving objects and moving objects such as third-party vehicles or the like. The objects can likewise be described as polygons and can be determined, for example, on the basis of measurement data obtained with the environment sensors 3 of the vehicle 1. The objects or object description assigned to the objects can be stored, by way of example, in an environment map, wherein the trajectory can be determined as a function of the environment map.

The method for determining the travel envelope results in a simple check for overlap due to the use of convex polygons to form the travel envelope or the at least one travel envelope segment. As a function of the collision check, the at least one actuator 4 of the vehicle 1 can be controlled by the control device 2, for example in order to perform a movement of the vehicle 1 along a travel trajectory 5 assessed as collision-free.

Alternatively, a movement of the vehicle 1 which is already taking place along the travel trajectory 5 can also be prevented, for example, if an impending collision with an object is detected. Such a collision can occur, for example, if the object is only detected due to the movement of the vehicle 1 and/or due to the object's own movement, so that the object could not be taken into account during the original planning of the travel trajectory 5. In the case of a non-moving vehicle, the travel trajectory 5 and/or at least one of the trajectory segments 6, 7 of the travel trajectory 5 can be determined again when the collision is determined in order to finally arrive at a travel trajectory 5 in which there is no risk of collision with objects in the surroundings.

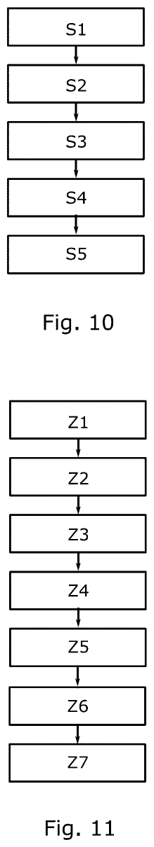

A block diagram which depicts the steps of the method for determining the travel envelope along a planned travel trajectory is depicted in FIG. 10, wherein the travel envelope approximates the area swept over by a vehicle during a movement along the travel trajectory and has at least one travel envelope segment (24, 26).

Step S1 denotes the provision of the travel trajectory 5 of the vehicle 1, wherein the travel trajectory 5 comprises at least one curved trajectory segment 6, 7, wherein a curvature of the travel trajectory 5 has a constant sign in the curved trajectory segment 6, 7.

Step S2 denotes the determination of at least a first polygon 8, the circumference of which describes a vehicle contour 10 at a first vehicle position 11 on the trajectory segment 6, 7, and a second polygon 9, the circumference of which describes the vehicle contour 10 at a second vehicle position 12 on the trajectory segment 6, 7.

Step S3 denotes the establishment of a pivot point 13 of the vehicle contour 10, which has the greatest distance from the curved line 14 during a movement of the vehicle 1 from the first vehicle position 11 to the second vehicle position 12, and approximation of the curved line 14 by at least two legs 16, 17 of at least one triangle 18 which encloses the curved line 14.

Step S4 denotes the formation of two convex polygons 22, 23, 27, 28 from the first polygon 8, the second polygon 9 as well as the at least two legs 16, 17 of the triangle 18 as a travel envelope segment 24, 26 of the curved trajectory segment 6, 7.

Step S5 denotes the determination of the travel envelope from the at least one travel envelope segment 24, 26.

A flow chart of a second exemplary embodiment of a method according to the invention, which can be performed by the control device 2 of the vehicle 1, is depicted in FIG. 11. Said second exemplary embodiment comprises method steps for determining a route along a travel trajectory which is to be driven by the vehicle 1 without collision.

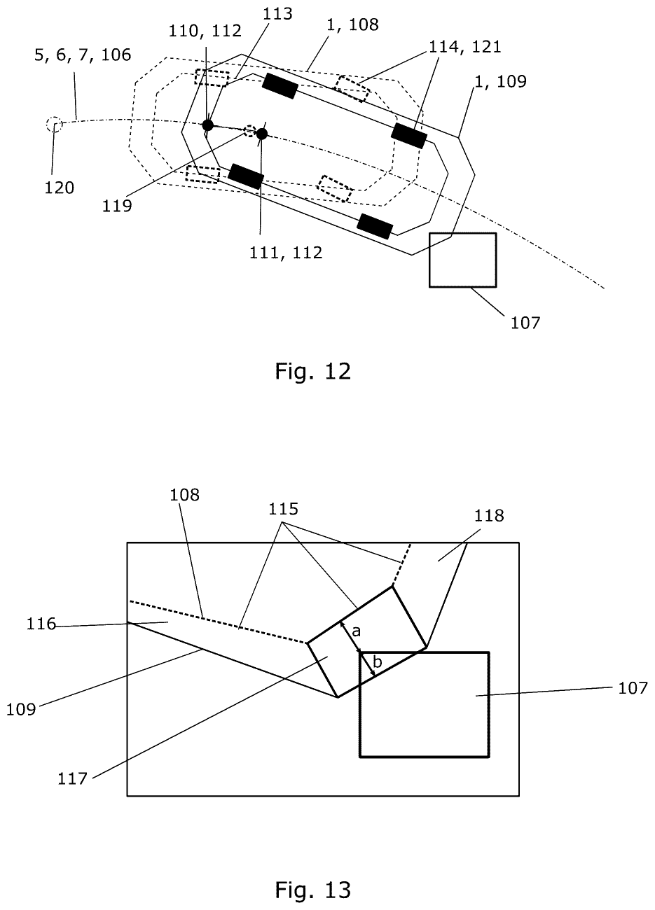

In the case of the second exemplary embodiment, steps S1 to S5 can be performed first. A collision check can subsequently be performed on the basis of the determined travel envelope and an item of map information which describes at least one object in the environment of the vehicle 1. If no collision is ascertained, the method can end following the collision check. If, however, a collision is ascertained, the method steps Z1 to Z7 can subsequently be performed according to the flow chart depicted in FIG. 11. The steps Z1 to Z7 are explained below with reference to FIGS. 12 and 13.

In step Z1 of the method, the travel trajectory 106 depicted as an example in FIG. 12 as well as object information are provided, wherein the object information describes the position of an object 7 colliding with the vehicle 1 during movement along the travel trajectory 6 relative to the travel trajectory 6 for the determination of the route to be driven without collision. The travel trajectory 106 is, by way of example, the travel trajectory 5 or at least one trajectory segment 6, 7 for which the travel envelope was determined. Alternatively, the travel trajectory 106 can also be another trajectory comprising at least one section of the travel trajectory 5 or at least one of the trajectory segments 6, 7 of said travel trajectory 5.

The travel trajectory 106 enlisted for the determination of the collision-free movement can in particular have a curvature with a constant sign, which changes continuously at least in sections. The travel trajectory 106 can be described, for example, by a clothoid curve or by a polynomial.

It is possible that a trajectory segment of a total travel trajectory which describes a driving maneuver, for example a parking maneuver, is used as the travel trajectory 106. That is to say that, as a consequence, a total travel trajectory assigned to a driving maneuver can be broken down into multiple trajectory segments, which each represent a travel trajectory 106, wherein the method for determining the route to be driven without collisions is performed correspondingly for one or more of the trajectory segments or travel trajectories 106.

The object information which describes that the object 107 will collide with the vehicle 1 during a movement of the vehicle 1 along the planned travel trajectory 106 can be determined, for example, from an item of map information which describes one or more objects 107 in the environment of the travel trajectory 106 and a travel envelope. The travel envelope can describe the area swept over by the vehicle 1 at least approximately when driving the travel trajectory 106. A collision can be detected if an object 107 overlaps with the travel envelope, if these are, for example, illustrated in a common coordinate system or corresponding geometric calculations are performed. The collision can in particular also be determined by the control device 2. Alternatively, the collision can be determined by a further computing device which transmits the object information and/or the map information to the vehicle 1.

Additionally or alternatively, the map information can also be determined as a function of sensor data which are obtained with the aid of the environment sensors 3 of the vehicle 1. The environment sensors 3 can for example capture the environment of the vehicle 1 both before the movement of the vehicle 1 along the travel trajectory 106 and during the movement of the vehicle 1 along the travel trajectory 106, so that the map information can be continually updated.

The position and arrangement of multiple items of contour information 108, 109 for various positions 110, 111 of the vehicle 1 along the travel trajectory 106 are subsequently determined in step Z2. The contour information 108 is assigned to a first position 110 of the vehicle 1 and the contour information 109 is assigned to a second position 111 of the vehicle 1 on the travel trajectory 106, wherein the positions 110, 111 relate, for example, to a rear axle center 112 of the vehicle 1. In the present case, the first position is closer to a starting point 120 of the travel trajectory 106 than the second position 111. The respective position and arrangement of the contour information 108, 109 correspond to the location and the orientation of the vehicle 1 in the positions 110, 111 when driving the travel trajectory 106.

The items of contour information 108, 109 are in each case a convex polygon, wherein the items of contour information 108, 109 each describe the same geometry or delimit an identical area segment. The contour 113 of the vehicle 1 is described in each case by the items of contour information 108, 109. The items of contour information 108, 109 each delimit an area segment which is larger than the actual contour 113 of the vehicle. In this way, safety margins as well as, if applicable, the space required for a movement of steerable wheels 114 of the vehicle 1 can likewise be taken into account when turning the wheels.

The positions 110, 111 at which the items of contour information 108, 109 are established can, for example, be determined on the basis of predefined, absolute length intervals along the travel trajectory 106. For example, a distance between 10 cm and 1 m can be chosen as the length interval, wherein other distances are also possible. Alternatively, it is possible that the length of the intervals between the positions 110, 111 is established relative to the total length of the travel trajectory 106. For example, a value between 1% and 10% of the total length of the travel trajectory 106 can be used as the distance between the positions. For the sake of clarity, only two items of contour information 108, 109 are depicted in FIG. 12, although further items of contour information can also be established at further positions along the travel trajectory 106 within the framework of the method.

It is possible that the vehicle positions 11, 12 are used as positions 110, 111. Alternatively, various positions 110, 111 can also be used. Correspondingly, it is possible that the previously determined polygons 8, 9, which are assigned to the positions 11, 12, are used as the items of contour information 108, 109, since both polygons equally describe a “snapshot” of the vehicle 1 at a specific position of the vehicle 1 on the trajectory 106. Consequently, recourse can also be had to the same mathematical or geometric description.

An item of contour information colliding with the object 107 and a collision-free item of contour information located closer to a starting point of the travel trajectory are determined in step Z3 of the method. In FIG. 12, the contour information 109 is the contour information colliding with the object 107. The contour information 108 is a collision-free item of contour information located closer to a starting point of the travel trajectory 106. The contour information 108 can for example be the contour information located adjacent to the colliding contour information 109 on the travel trajectory 106 from the set of previously established contour information.

The collision between the contour information 109 and the object 107 can be ascertained, for example, by an overlap of the contour information 109 with the object 107 which is likewise described as a polygon, for example. Correspondingly, there is no collision between the contour information 108 and the object 107, since they do not overlap. If multiple items of the contour information collide with an object 107, that item of contour information which is closest to the starting point 120 of the travel trajectory 106 or which collides with an object 107 closest to the starting point 120 can, for example, be selected as the colliding contour information 109. The item of contour information closest to the starting point 120 or the object 107 closest to the starting point 120 can for example be selected in relation to the vehicle movement along the travel trajectory 106.

The area between the collision-free contour information 108 and the colliding contour information 109 is subsequently divided into multiple cells 116, 117, 118, which are assigned in each case to a contour section 115 of the contour information 108, 109 in step Z4 of the method, as depicted as an example in FIG. 13. FIG. 13 depicts a detail of the scene shown in FIG. 12, wherein the items of contour information 108, 109 are located closer together for reasons of clarity, or the scene illustrated in FIG. 13 uses a first position 110 and a second position 111, which are located closer to one another on the travel trajectory 106. A straight edge of the items of contour information 108, 109 is used as the contour section 115, wherein the cells extend in each case between the corresponding edge of the collision-free contour information 108 and the colliding contour information 109.

Thereafter, a cell 116-118 overlapping with the object 107 is determined in step Z5. In the example depicted in FIG. 13, the cell 117 overlaps with the object 107, so that the cell 117 is determined as an overlapping cell. Furthermore, a collision-free portion R of the movement of the circumferential section 115 assigned to the overlapping cell in the overlapping cell 117 is established. The collision-free portion expresses, by way of example, the portion of the route which can be covered by the circumferential section 115 from the collision-free contour information 108 to the colliding contour information 109 without coming into contact with the object 107. The collision-free portion R can be calculated, by way of example, by means of the formula

$$R = a / ( a + b ) \qquad ( 1 )$$

wherein a describes the length of the collision-free route section and b describes the length of the route section which already runs within the object 107 and consequently collides with the object.

In the event that the contour information 109 collides with two or more objects 107, at least one further item of contour information can be determined, wherein the further item of contour information is established for example at a further position on the travel trajectory 106, which is located between the original positions 110, 111 of the originally enlisted, colliding contour information 109 and the collision-free contour information 108.

A collision position 119 on the travel trajectory 106 is subsequently established as a function of the collision-free portion R in step Z6 of the method. A collision position 119 is drawn in schematically in FIG. 12. The collision position 119 is located between the position 110 of the collision-free contour information 108 and the position 111 of the colliding contour information 109.

The collision position 119 can be determined, for example, on the basis of the collision-free portion R and the route between the positions 110, 111 and/or the change in curvature of the travel trajectory 106 between the positions 110, 111. Starting from the position 110, a portion of the route or the change in curvature corresponding to the portion R can be taken into account in order to establish the collision position 119 starting from the first position 10. In other words, the portion R of the route or the change in curvature between the position 110 and the position 111 is consequently used as the route or the change in curvature between the position 110 and the collision position 111. In this way, the collision position 119 can be established or approximated with little effort. The change in curvature can be taken into account for example in the case of a travel trajectory 106 which is described as a clothoid, which has a constant change in curvature.

A collision-free movement of the vehicle 1 can subsequently be determined as a function of the collision position 119 in step Z7 of the method. For example, the collision-free movement can be determined up to an end point which is offset by a safety margin from the collision position 119 in the direction of the starting point 120 of the travel trajectory 106. During a movement of the vehicle 1 up to this end point, a collision between the vehicle 1 and the object 107 can consequently be avoided. The collision-free movement can be effected, for example, by the at least one actuator 4 of the vehicle 1 being controlled by the control device 2.

The steps Z1-Z7 for determining the route to be driven without collision can be effected prior to a movement of the vehicle 1 along the travel trajectory 106. It is also possible that the method is performed again if, during the movement of the vehicle 1 along the travel trajectory 106, further objects 107 are detected in the environment of the vehicle 1 and are assessed as colliding objects 107, for example by comparing them with a travel envelope. This can be the case, by way of example, if moving objects are present in the environment of the vehicle 1 and/or if objects are present which could not be detected from the starting point 120 of the travel trajectory 106, for example due to shadowing and/or the presence of further objects.

It is possible that instead of the items of contour information 108, 109 which describe a vehicle contour, an item of contour information 108, 109 which describes a part 121 of the vehicle 1 is used in each case. In this way, a collision between the vehicle part 121, which can for example be a vehicle part which is movable relative to a body of the vehicle 1, for example one of the wheels 114 of the vehicle 1, can be determined.

Similarly to the previously described exemplary embodiment, in which the items of contour information 108, 109 which describe a contour of the vehicle 1 were used, a collision between the movable vehicle part 121 and the object 107 can also be determined correspondingly. The items of contour information 108, 109 can also take into account the relative arrangement of the vehicle part 121 in the respective position 110, 111, which, in the case of a wheel 114 of the vehicle 1, can be produced, by way of example, by the current steering angle.

The collision position or the vehicle position along the travel trajectory 106 at which no collision occurs can correspondingly be determined, taking into account the relative arrangement of the vehicle part 121 on the vehicle 1, from the collision-free portion R of the movement of the vehicle part 121 obtained by means of the method.

1. A method for determining a travel envelope along a travel trajectory comprising:
providing the travel trajectory of the vehicle, wherein the travel trajectory comprises at least one curved trajectory segment, wherein a curvature of the travel trajectory has a constant sign in the at least one curved trajectory segment;
determining at least a first polygon, the circumference of which describes a vehicle contour at a first vehicle position on the at least one curved trajectory segment, and a second polygon, the circumference of which describes the vehicle contour at a second vehicle position on the at least one curved trajectory segment;
establishing a pivot point of the vehicle contour, which has the greatest distance from a curved line during a movement of the vehicle from the first vehicle position to the second vehicle position;
approximating the curved line by at least two legs of at least one triangle which encloses the curved line;
forming at least one travel envelope segment of the at least one curved trajectory segment from two convex polygons from the first polygon, the second polygon and the at least two legs of the triangle; and
determining the travel envelope from the at least one travel envelope segment.

2. The method according to claim 1, wherein the travel trajectory has at least one of a curvature of which changes continuously at least in sections, is a clothoid curve and is a polynomial used as the travel trajectory.

3. The method according to claim 1, wherein the vehicle contour described by the first polygon and the second polygon corresponds to the actual contour of the vehicle increased by a safety margin.

4. The method according to claim 1, wherein the at least one triangle is formed by at least two tangents on the curved line in the respective pivot point in the first position and the second position and a straight line connecting the contact points of the tangents on the curved line.

5. The method according to claim 1, wherein the first vehicle position is located at a starting point of the trajectory segment and the second vehicle position is located at an end point of the trajectory segment, or at least one of the first vehicle position and the second vehicle position is located between a starting point and an end point of the trajectory segment.

6. The method according to claim 1, wherein the distance between the first vehicle position and the second vehicle position along the travel trajectory is established as a function of a height limit value which describes a maximum permissible height for the at least one triangle.

7. The method according to claim 1, wherein the two convex polygons are formed such that, together, they completely comprise at least the first polygon, the second polygon and the area comprised by the at least one triangle.

8. The method according claim 1, further comprising performing a collision check as a function of the determined travel envelope and map information which describes at least one object in the environment of the travel trajectory.

9. The method according to claim 8, further comprising determining a route to be driven by the vehicle along the travel trajectory without collision is determined when at least one object colliding with the vehicle during movement along the travel trajectory is determined during the collision check.

10. A control device computer readable medium with instructions for:
providing a travel trajectory of a vehicle, wherein the travel trajectory comprises at least one curved trajectory segment, wherein a curvature of the travel trajectory has a constant sign in the at least one curved trajectory segment;
determining at least a first polygon, the circumference of which describes a vehicle contour at a first vehicle position on the at least one curved trajectory segment, and a second polygon, the circumference of which describes the vehicle contour at a second vehicle position on the at least one curved trajectory segment;
establishing a pivot point of the vehicle contour, which has the greatest distance from a curved line during a movement of the vehicle from the first vehicle position to the second vehicle position;
approximating the curved line by at least two legs of at least one triangle which encloses the curved line;
forming at least one travel envelope segment of the at least one curved trajectory segment from two convex polygons from the first polygon, the second polygon and the at least two legs of the triangle; and
determining the travel envelope from the at least one travel envelope segment.

11. The control device according to claim 10, wherein the control device is for the vehicle.

12. A computer program comprising commands which prompt a control device to carry
providing a travel trajectory of a vehicle, wherein the travel trajectory comprises at least one curved trajectory segment, wherein a curvature of the travel trajectory has a constant sign in the at least one curved trajectory segment;
determining at least a first polygon, the circumference of which describes a vehicle contour at a first vehicle position on the at least one curved trajectory segment and a second polygon, the circumference of which describes the vehicle contour at a second vehicle position on the at least one curved trajectory segment;
establishing a pivot point of the vehicle contour, which has the greatest distance from a curved line during a movement of the vehicle from the first vehicle position to the second vehicle position;
approximating the curved line by at least two legs of at least one triangle which encloses the curved line;
forming at least one travel envelope segment of the at least one curved trajectory segment from two convex polygons from the first polygon, the second polygon and the at least two legs of the triangle; and
determining the travel envelope from the at least one travel envelope segment.
